(19) United States
(12) Patent Application Publication
(10) Pub. No.: US 2025/0183412 A1
(43) Pub. Date: Jun. 5, 2025

(54) SYSTEMS AND METHODS FOR MITIGATING THERMAL PROPAGATION WITHIN TRACTION BATTERY ARRAYS

(71) Applicant: FORD GLOBAL TECHNOLOGIES, LLC, Dearborn, MI (US)

(72) Inventors: Jianwen Yi, West Bloomfiled, MI (US); Adam Denlinger, Saline, MI (US); Steven Wooldridge, Manchester, MI (US); Wen Dai, Northville, MI (US); Brad Alan VanDerWege, Plymouth, MI (US); James Alfred Hilditch, Canton, MI (US)

(21) Appl. No.: 18/527,830

(22) Filed: Dec. 4, 2023

(51) Int. Cl. H01M 10/6567; B60L 50/64; H01M 10/613; H01M 10/625; H01M 50/249; H01M 50/271; H01M 50/30

(52) U.S. Cl. CPC H01M 10/6567; B60L 50/64; H01M 10/613; H01M 10/625; H01M 50/249; H01M 50/271; H01M 50/394; H01M 2220/20

(57) ABSTRACT

Battery arrays are provided for traction battery packs. An exemplary battery array may include one or more internal compartments. Each compartment may contain a non-conductive coolant for mitigating or even preventing cell-to-cell thermal propagation. An air gap of the compartment may provide a venting path for venting battery vent byproducts during a battery thermal event.

### TECHNICAL FIELD

This disclosure relates generally to traction battery packs, and more particularly to systems and methods for mitigating thermal propagation within a traction battery array during battery thermal events.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A battery array for a traction battery pack according to an exemplary aspect of the present disclosure includes, among other things, an outer array housing, a cell stack housed inside the outer array housing, a compartment extending between the outer array housing and the cell stack, and a non-conductive coolant contained within the compartment and configured to limit thermal propagation across the cell stack during a battery thermal event.

In a further non-limiting embodiment of the foregoing battery array, the compartment extends between a top surface of the cell stack and an inner surface of a top plate of the outer array housing.

In a further non-limiting embodiment of either of the foregoing battery arrays, the non-conductive coolant is disposed in direct contact with a plurality of battery cells of the cell stack but does not directly contact the top plate.

In a further non-limiting embodiment of any of the foregoing battery arrays, the non-conductive coolant is contained within a fluid-filled portion of the compartment. The compartment further includes an air gap portion above the fluid-filled portion.

In a further non-limiting embodiment of any of the foregoing battery arrays, a slotted plate establishes a physical interface between the fluid-filled portion and the air gap portion.

In a further non-limiting embodiment of any of the foregoing battery arrays, the slotted plate includes a plurality of through-holes.

In a further non-limiting embodiment of any of the foregoing battery arrays, the air gap portion is an open space extending from the fluid-filled portion to an inner surface of a plate of the outer array housing.

In a further non-limiting embodiment of any of the foregoing battery arrays, the plate is a top plate of the outer array housing.

In a further non-limiting embodiment of any of the foregoing battery arrays, the air gap portion provides a venting path for venting battery vent byproducts during the battery thermal event.

In a further non-limiting embodiment of any of the foregoing battery arrays, the non-conductive coolant is a dielectric fluid.

A battery array for a traction battery pack according to another exemplary aspect of the present disclosure includes, among other things, an outer array housing, a cell stack housed inside the outer array housing, a compartment extending between the outer array housing and the cell stack, and a slotted plate positioned to divide the compartment between a fluid-filled portion and an air gap portion.

In a further non-limiting embodiment of the foregoing battery array, a non-conductive coolant is contained within the fluid-filled portion and is configured to limit thermal propagation across the cell stack during a battery thermal event.

In a further non-limiting embodiment of either of the foregoing battery arrays, the non-conductive coolant is a dielectric fluid.

In a further non-limiting embodiment of any of the foregoing battery arrays, the compartment extends between a top surface of the cell stack and an inner surface of a top plate of the outer array housing.

In a further non-limiting embodiment of any of the foregoing battery arrays, a non-conductive coolant is disposed in direct contact with a plurality of battery cells of the cell stack but does not directly contact the top plate.

In a further non-limiting embodiment of any of the foregoing battery arrays, the slotted plate establishes a physical interface between the fluid-filled portion and the air gap portion and includes a plurality of through-holes.

In a further non-limiting embodiment of any of the foregoing battery arrays, the air gap portion is an open space extending from the fluid-filled portion to an inner surface of a plate of the outer array housing.

In a further non-limiting embodiment of any of the foregoing battery arrays, the plate is a top plate of the outer array housing.

In a further non-limiting embodiment of any of the foregoing battery arrays, the air gap portion provides a venting path for venting battery vent byproducts during a battery thermal event of the battery array.

In a further non-limiting embodiment of any of the foregoing battery arrays, the venting path extends through a through-hole of the slotted plate.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 illustrates a battery array of a traction battery pack.

FIG. 3 is a cross-sectional view through section 3-3 of FIG. 2.

FIG. 4 illustrates select portions of another exemplary battery array for a traction battery pack.

### DETAILED DESCRIPTION

This disclosure details battery arrays for traction battery packs. An exemplary battery array may include one or more internal compartments. Each compartment may contain a non-conductive coolant for mitigating or even preventing cell-to-cell thermal propagation. An air gap of the compartment may provide a venting path for venting battery vent byproducts during a battery thermal event. These and other features are discussed in greater detail in the following paragraphs of this detailed description.

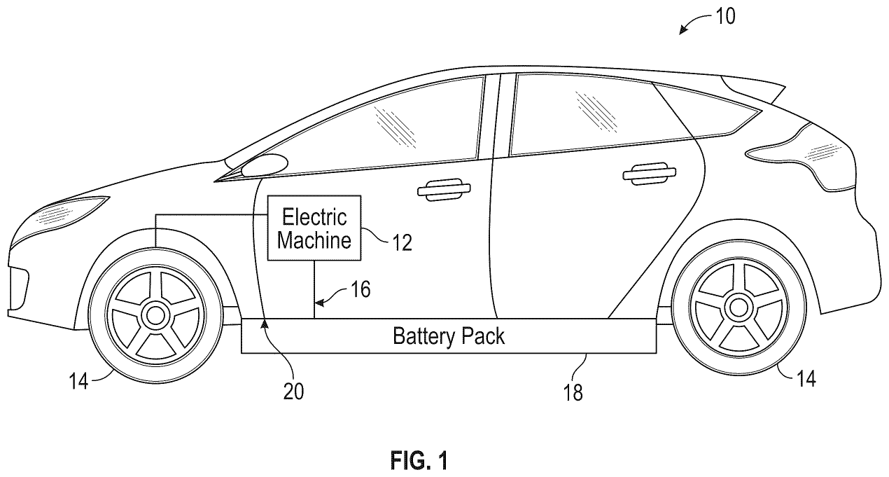

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cell groupings capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

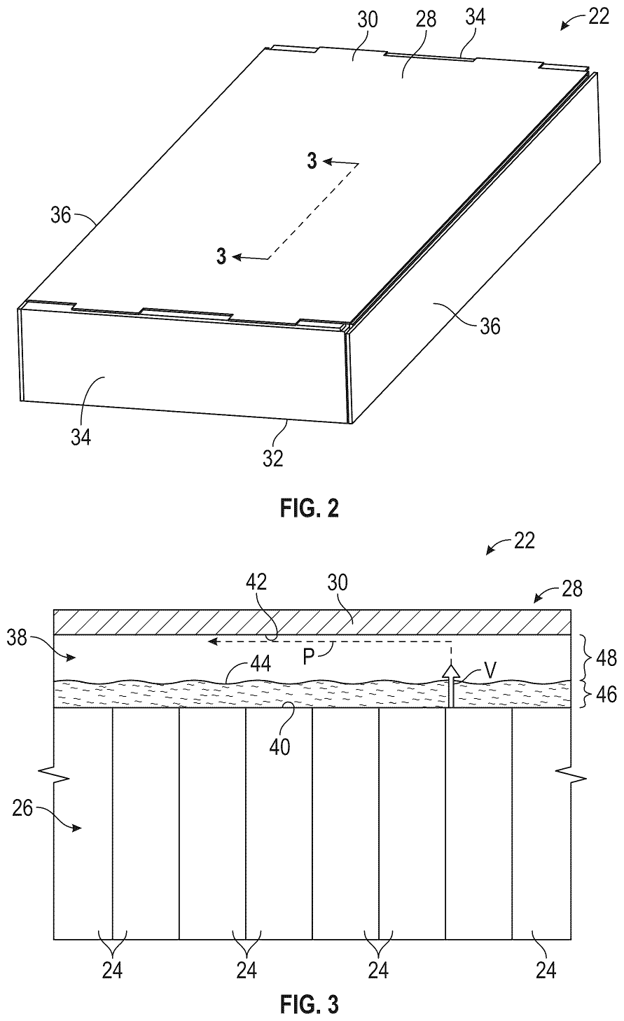

FIGS. 2 and 3 illustrate an exemplary battery array 22 for a traction battery pack, such as the traction battery pack 18 of FIG. 1, for example. One or more battery arrays having a design similar to the battery array 22 shown in FIGS. 2-3 could be packaged within the traction battery pack 18.

The battery array 22 may include a plurality of battery cells 24 (see FIG. 3). In an embodiment, the battery cells 24 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The total number of battery cells 24 provided within the battery array 22 may vary and is not intended to limit this disclosure.

The battery cells 24 may be stacked side-by-side along a stack axis to construct a grouping of battery cells 24 or cell stack 26. The cell stack 26 of the battery array 22 may be sub-grouped into two or more cell banks. The battery cells 24 may be held in compression relative to one another within the cell stack 26.

An outer array housing 28 of the battery array 22 may be arranged to substantially surround the battery cells 24 of the cell stack 26. In an embodiment, the array outer housing 28 completely encloses the battery cells 24 of the cell stack 26 and includes a top plate 30, a bottom plate 32, a pair of end plates 34, and a pair of side plates 36. One or more of the top plate 30, the bottom plate 32, the end plates 34, and the side plates 36 may be integrated together as part of a unitary structure. For example, the bottom plate 32 and the end plates 34 could be integrated together to form a unitary array structure that interfaces with the top plate 30. However, other configurations of the outer array housing 28 are also possible within the scope of this disclosure.

Referring now primarily to FIG. 3, one or more compartments 38 may be provided within the battery array 22. Each compartment 38 is an open space that extends inside the battery array 22. For example, the compartment 38 may extend between top surfaces 40 of the battery cells 24 of the cell stack 26 and an inner surface 42 of the top plate 30 of the outer array housing 28. However, other arrangements are contemplated within the scope of this disclosure, and therefore the compartment 38 could alternatively or additionally extend between the cell stack 26 and any of the plates of the outer array housing 28.

The compartment 38 may be partially filled with a non-conductive coolant 44, thus subdividing the compartment 38 into a fluid-filled portion 46 and an air gap portion 48. The fluid-filled portion 46 may extend from the top surfaces 40 of the battery cells 24 to the air gap portion 48, and the air gap portion 48 may extend in the open space between the non-conductive coolant 44 and the inner surface 42 of the top plate 30. The non-conductive coolant 44 may therefore be in direct contact with the battery cells 24 but is generally not in direct contact with the top plate 30. Among other functions, the air gap portion 48 may provide an open space for accommodating expansion of the battery cells 24. In other implementations, the compartment 38 may be completely filled with the non-conductive coolant 44.

The non-conductive coolant 44 may be a dielectric fluid, such as a Novek™ engineered fluid sold by 3M™, for example. However, other non-conductive coolants may also be suitable, and the actual chemical make-up and design characteristics (e.g., dielectric constant, maximum breakdown strength, boiling point, etc.) of the non-conductive coolant 44 may vary depending on the environment the battery array 22 is to be employed within.

Although rare, the battery array 22 could experience a battery thermal event during its operation. A battery thermal event may occur, for example, during over-charging conditions, over-discharging conditions, or other conditions and can cause one or more of the battery cells 24 to expel battery vent byproducts V that can include gases, effluent particles, and/or other vent byproducts. During such a battery thermal event, the non-conductive coolant 44 contained within the fluid-filled portion 46 of the compartment 38 may substantially reduce or even prevent battery vent byproduct V-to-cell convective heat transfer, thereby substantially mitigating thermal propagation across the cell stack 26. Moreover, the air gap portion 48 of the compartment 38 may establish a dedicated venting path P for expelling the battery vent byproducts V from the battery array 22 during the battery thermal event. For example, the battery vent byproducts V may be communicated through the fluid-filled portion 46 and then flow across the inner surface 42 of the top plate 30 without passing directly over the battery cells 24 when traveling along the venting path P. Although not specifically shown, the battery vent byproducts V may eventually be expelled to a location outside of the battery array 22 (e.g., external to the outer array housing 28) after matriculating into the air gap portion 48.

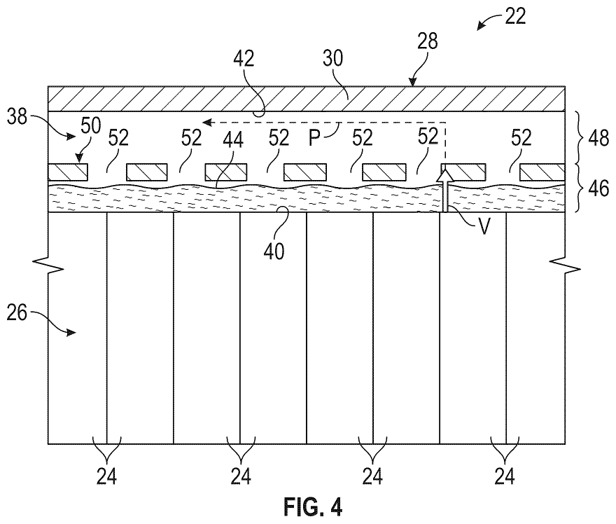

Referring now to FIG. 4, a slotted plate 50 may optionally be disposed within the compartment 38. The slotted plate 50 may be positioned to establish a physical interface between the fluid-filled portion 46 of the compartment 38 that contains the non-conductive coolant 44 and the air gap portion 48 of the compartment 38 that does not contain the non-conductive coolant 44. The slotted plate 50 may be configured to maintain the non-conductive coolant 44 in contact with the battery cells 24. Through-holes 52 may be formed through the slotted plate 50 and can allow the battery vent byproducts V to flow through the slotted plate 50 when traveling along the venting path P during a battery thermal event.

The exemplary battery arrays of this disclosure include systems and methods for mitigating or event preventing thermal propagation inside electrified vehicle traction battery arrays. The proposed systems may provide numerous advantages over known solutions, including but not limited to presenting a novel configuration that significantly slows or even prevents cell-to-cell thermal propagation while providing dedicated venting passageways for expelling battery vent byproducts during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery array for a traction battery pack, comprising:
an outer array housing;
a cell stack housed inside the outer array housing;
a compartment extending between the outer array housing and the cell stack; and
a non-conductive coolant contained within the compartment and configured to limit thermal propagation across the cell stack during a battery thermal event.

2. The battery array as recited in claim 1, wherein the compartment extends between a top surface of the cell stack and an inner surface of a top plate of the outer array housing.

3. The battery array as recited in claim 2, wherein the non-conductive coolant is disposed in direct contact with a plurality of battery cells of the cell stack but does not directly contact the top plate.

4. The battery array as recited in claim 1, wherein the non-conductive coolant is contained within a fluid-filled portion of the compartment, and wherein the compartment further comprises an air gap portion above the fluid-filled portion.

5. The battery array as recited in claim 4, wherein a slotted plate establishes a physical interface between the fluid-filled portion and the air gap portion.

6. The battery array as recited in claim 5, wherein the slotted plate includes a plurality of through-holes.

7. The battery array as recited in claim 4, wherein the air gap portion is an open space extending from the fluid-filled portion to an inner surface of a plate of the outer array housing.

8. The battery array as recited in claim 7, wherein the plate is a top plate of the outer array housing.

9. The battery array as recited in claim 4, wherein the air gap portion provides a venting path for venting battery vent byproducts during the battery thermal event.

10. The battery array as recited in claim 1, wherein the non-conductive coolant is a dielectric fluid.

11. A battery array for a traction battery pack, comprising:
an outer array housing;
a cell stack housed inside the outer array housing;
a compartment extending between the outer array housing and the cell stack; and
a slotted plate positioned to divide the compartment between a fluid-filled portion and an air gap portion.

12. The battery array as recited in claim 11, comprising a non-conductive coolant contained within the fluid-filled portion and configured to limit thermal propagation across the cell stack during a battery thermal event.

13. The battery array as recited in claim 12, wherein the non-conductive coolant is a dielectric fluid.

14. The battery array as recited in claim 11, wherein the compartment extends between a top surface of the cell stack and an inner surface of a top plate of the outer array housing.

15. The battery array as recited in claim 14, wherein a non-conductive coolant is disposed in direct contact with a plurality of battery cells of the cell stack but does not directly contact the top plate.

16. The battery array as recited in claim 11, wherein the slotted plate establishes a physical interface between the fluid-filled portion and the air gap portion and includes a plurality of through-holes.

17. The battery array as recited in claim 11, wherein the air gap portion is an open space extending from the fluid-filled portion to an inner surface of a plate of the outer array housing.

18. The battery array as recited in claim 17, wherein the plate is a top plate of the outer array housing.

19. The battery array as recited in claim 11, wherein the air gap portion provides a venting path for venting battery vent byproducts during a battery thermal event of the battery array.

20. The battery array as recited in claim 19, wherein the venting path extends through a through-hole of the slotted plate.
